(19) United States
(12) Patent Application Publication
(10) Pub. No.: US 2014/0236630 A1
(43) Pub. Date: Aug. 21, 2014

(54) SYSTEM AND METHODS FOR HEALTH ANALYTICS USING ELECTRONIC MEDICAL RECORDS

(71) Applicant: STC.UNM, Albuquerque, NM (US)

(72) Inventor: Glen H. Murata, Albuquerque, NM (US)

(21) Appl. No.: 14/181,907

(22) Filed: Feb. 17, 2014

Related U.S. Application Data
(60) Provisional application No. 61/765,151, filed on Feb. 15, 2013.

(51) Int. Cl. G06Q 50/22; G06Q 10/06

(52) U.S. Cl. CPC G06Q 50/22; G06Q 10/06398
USPC 705/3

(57) ABSTRACT

System and methods for collecting, sharing and analyzing data of Electronic Medical Records (EMRs) for improved health analytics. Quality of health care delivery is assessed and improved through use of data from EMRs. For example, data may be analyzed for a variety of purposes, including to determine variation in performance of a practice site, a group practice, or an individual clinician for the patient population on a given treatment or to identify a risk of disease for patients of the patient population.

### CROSS-REFERENCE TO RELATED APPLICATIONS

This application claims the benefit of priority to U.S. Provisional Application No. 61/765,151, filed Feb. 15, 2013, which is incorporated by reference in its entirety.

### FIELD OF THE INVENTION

The invention relates generally to health care including health care systems and methods. More specifically, the invention relates to a system and methods for analyzing data of an Electronic Medical Record (EMR) including for evaluation and treatment of chronic disease.

### BACKGROUND OF THE INVENTION

Problems of poor outcomes, high costs, and declining primary care workforce persist in the national health care system because the health care delivery system is based on an acute care model. Typically, a patient seeks health care only in response to symptoms, placing the onus for initial contact on the patient, often the person with the least knowledge of the condition or illness in question. Planning by the physician is done on a case-by-case basis for only those patients seeking care. Finally, intervention is typically reactive, offered to ameliorate a condition only after it has progressed to the point that the patient is symptomatic, when the opportunity to treat the condition in an earlier, more responsive stage is lost.

These problems are compounded by reliance upon the outpatient visit as the principal means of delivering medical services. The “visit-based” approach often precludes services from being received by the neediest patients, i.e., those with access barriers who never present for treatment. Progress is tied to the next available appointment, not to the responsiveness of the disease to treatment. For example, in the case of diabetes management, insulin titrations often occur over several months even though treatment response can be assessed in just a few days.

As known in the art, dashboard systems are used to present current or contemporary information about a patient, for example, laboratory results. However, these systems are limited in that they do not provide enough information to determine which results are actionable. Dashboards present large volumes of unprocessed data that have to be interpreted out-of-context unless the clinician wants to do a chart review on every case. Chart reviews are rarely built into the workday and may require skills that he or she does not have. After such an effort has been made, it is infuriating to learn that the abnormality has already been treated. The burden of alerts is placed upon the person least able to hand it which impairs the delivery of care to other patients. Finally, the large volume of data makes it even more difficult for the clinicians to prioritize their tasks and tend to patients who need them the most.

Administrative processes and financial incentives still favor the acute-care, visit-based approach, despite its disadvantages. Examples include the requirement that a “primary diagnosis” for an outpatient encounter be identified and higher reimbursement for an office visit than an equally effective telephone call.

Health analytics involves the extensive use of data, statistical and qualitative analysis, explanatory and predictive modeling. Current art in health analytics is based upon administrative databases. One such administrative database is a claims database that includes records consisting of claims for services provided by organizations or individual providers. Unfortunately, there are many problems associated with the use of such data for health analytics. Important categories of clinical data do not result in charges (e.g. vital signs, drug allergies). As a result, claims databases often do not have large domains of data of vital importance to clinicians. More problematic is that claims databases capture what procedures were done but not the results. For example, the data set may contain charges for antibiotic sensitivities for a bacterial isolate but not the results for each antibiotic tested.

Furthermore, claims data use billing codes and terminology (e.g. CPT-4), while clinical data is organized by medical taxonomies (e.g. SNOMED-CT). Lack of appropriate coding or standardized nomenclature makes the retrieval of information difficult.

In addition, it is rarely necessary to link certain charges with others, while it is very important to link clinical findings with one another. Claims databases may not meet the requirements of a highly normalized relational data system that allows these relationships to be analyzed.

Claims are submitted to maximize reimbursement—not to describe the process of care. As a result, there is dissociation between what is billed and what transpired.

There can be a substantial delay in the capture of claims data because of time required for claims processing, review, and final determination. Claims data is therefore of limited utility for real time decision support.

In addition, most claims data systems require data transfer agreements between insurance carriers and health care systems. These agreements often require extensive negotiation in areas of legal liability, protection of patient information, authorization/authentication of users, physical security measures, etc.

Many carriers are unwilling to participate in these arrangements because the risks are not offset by the rewards. Furthermore, patients may change insurance plans frequently and often involuntarily. This problem results in a fragmentation of information across health plans. While the active carrier may provide information about the patient's current status, it may not have enough information to evaluate long term process of care.

The Health Information Technology for Economic and Clinical Health (HITECH) Act of 2010 was designed to promote the widespread adoption of EMRs so that clinical data would eventually be available for these purposes. There has been a steady increase in the adoption of EMRs in response to financial incentives. However, the definitions for “meaningful use”—a mandatory requirement—does not include analysis of data across populations. As a result, many commercial products are designed to meet HITECH standards but not maximize outcomes, lower costs, or improve efficiency. Open health care systems are faced with an additional barrier. These systems typically do not have their own pharmacies or laboratories and rely heavily on outside vendors for these services. Important sources of clinical data for a population of interest can thus accrue in separate repositories. Their consolidation into a comprehensive database requires the additional steps of data transfer and integration.

All accredited health care institutions must have quality assurance programs and undergo periodic audits by outside organizations. Clinicians must be licensed, pass certifying exams, participate in continuing medical education, and be reviewed by their peers on a regular basis. At first glance, it is surprising that these collective efforts have failed. However, current quality improvement processes adopted by institutions have critical deficiencies.

First, the current processes are limited in scope. At any moment in time, only a small proportion of clinicians and processes are under review. Cases usually come to attention only when there is an egregious outcome that results in a malpractice suit. “Root cause analysis” then focuses upon a few individuals or the one or two processes that were the immediate cause. The likelihood that most practitioners will benefit from (or even be aware of) the changes is small. Much greater improvement can be achieved by correcting less egregious problems affecting the entire enterprise. Thus, the emphasis should change from managing outliers to improving accepted but suboptimal standards of practice used by everyone else.

Second, most audits performed by quality improvement services are retrospective—whether the reviews are prompted by an adverse event or randomly selected. This approach guarantees that patients will be exposed to some period of risk. For most facilities, “risk management” does little to manage risk—that is, to reduce exposures before an adverse event. Instead, the term usually refers to identifying culpable parties, crafting a legal defense, and negotiating financial settlements after such events have occurred. Meaningful risk management should decrease the probability of unfavorable outcomes, shorten the period of exposure, or reduce their impact. This goal can be achieved by evaluating processes every day and across the enterprise; changing those that pose high risk; and more closely observing patients for whom the risk cannot be reduced. For example, “missed” cancer screening tests should be identified today to reduce the incident of advanced stage malignancies in the future. Patients not taking their medications today should undergo counseling to prevent unfavorable events later. Those with declining renal function should be referred to nephrology today to decrease the likelihood that they will require dialysis. Thus, effective risk management requires regular and real-time retrieval of information about a health system's most critical processes.

Third, manual reviews of paper charts are resource-intensive, time-consuming, and expensive—if the charts can be found at all. Data are often manually extracted onto paper forms and hand-tabulated. The conclusions are then summarized but may not be disseminated to the clinical staff. The preferred strategy is to use information technology to assemble data that is standardized, coded, and stored in an electronic format. Chart reviews should be reserved only for audits involving non-standardized data not easily retrieved. This approach makes optimal use of the reviewer's skill and time and avoids hand-processing of large amounts of data—a task which humans do poorly. In other words, people should focus on tasks that are “patient-centric” while computers should handle tasks that are “data centric”.

Fourth, current processes provide inadequate sampling. Treatment outcomes can vary greatly because of differences in patient attitudes, motivation, health literacy, behaviors, access to care, cultural beliefs, socio-economic status, and other factors beyond the influence of the most competent clinician. Only a large sample provides a meaningful estimate of performance when there is large variation in the outcome metric. Thus, limited sampling defeats the replication of “best practices” at the first step—distinguishing good processes from bad ones. Fifth, current processes include meaningless comparisons. Patients differ in many clinical factors that influence the outcome such as genetic predisposition to disease, physiologic traits, severity of illness, co-morbidities, types of treatment, and time on treatment. In standard assessments of quality, almost no attention is paid to clinical determinants of the outcome. As a result, differences between providers may be falsely attributed to the quality of their care when the cause is a difference in the patients they treat. These comparisons become meaningful if there are controls for these covariates—that is, using statistics to eliminate the effect of patient attributes. This process requires retrieving large volumes of material in many domains and multivariate statistical methods. Because most quality improvement programs do not use such a sophisticated approach, the improvement process is again defeated at the first step.

Lastly, some current processes are rated against standards that may be irrelevant to the population at hand. For example, providers are often rated by their adherence to practice guidelines. Unfortunately, it is often unclear if such guidelines are feasible for or even relevant to their practices. Many recommendations are based upon randomized clinical trials conducted in academic medical centers. These studies involve highly motivated and informed subjects; pay participants for their time and effort; offer the intervention for free; provide immediate access to world experts; follow a fairly rigid protocol; are monitored at all times by highly trained personnel; and last for a short time. Patients who have unfavorable attitudes, behaviors, or mental functioning; cannot afford the time or travel; or have cultural barriers to care do not participate at all. As a result, the findings of the trial may not be relevant when the intervention is used in a different population. The preferred approach is to gather information on the feasibility and impact of the intervention in the entire population served by the health system. The standard should be internal—that is, the best that can be achieved with that intervention given the local population and circumstances.

These observations suggest that a dramatic improvement in quality, efficiency, and cost can be achieved if large volumes of data can be retrieved on every patient and provider in real-time; data are analyzed in a rigorous manner; and the results used to target the institution's highest priorities at any given time.

Therefore, there is a need for improved health analytics including analytics that create a new standard for quality improvement and cost containment activities. The invention uses Electronic Medical Records (EMRs) to satisfy this need. Information from EMRs is superior to administrative data in terms of content, quality, relevance and timeliness. Accordingly, analysis of such data produces a more accurate assessment of clinical status than can be derived from claims.

### SUMMARY OF THE INVENTION

According to the invention, data is collected, shared, and analyzed. Data collection can be characterized by the adoption and meaningful use of Electronic Medical Records (EMRs). Data sharing is characterized by the distribution of findings to every part of the organization responsible for the patient's care. Data analysis is characterized by the adoption of enterprise data warehouses and analytic tools.

Instead of an administrative database such as a claims database, the invention uses information derived from EMRs. The invention is based upon a far more sophisticated approach to health analytics that takes full advantage of a robust data repository built from EMRs. An EMR is a systematic collection of electronic health information about individual patients or populations. An EMR is essentially a digital version of a paper chart in a clinician's office. It contains the medical and treatment history of patients and can be grouped to represent patients in a particular practice.

An EMR allows a clinician to track data over time, easily identify which patients are due for preventative screenings, check how patients are doing on certain parameters such as blood pressure readings or vaccines and monitor and improve overall quality of care within the practice. EHRs may include a range of data including demographics, medical history, medication and allergies, immunization status, laboratory test results, radiology images, vital signs, and demographics like age.

An EMR is said to make the process of patient record-keeping easier, more accurate and comprehensive, and more efficient. Physicians can use a desktop, laptop or electronic clipboard to navigate through patients' charts and record notes. Other types of data can be downloaded into EMRs from outside data sources. The greatest advantage is that all information can be aggregated into a single data source, and multiple users can access that data simultaneously. EMRs minimize the problems of lost charts or missing reports and often have functionalities that improve patient flow and help the clinician make complicated decisions.

EMRs are capable of being shared across different health care settings. In some cases, this sharing can occur by way of network-connected, enterprise-wide information systems and other information exchanges involving multiple health care institutions.

The invention derives highly relevant parameters from complex analysis or robust statistical treatment of raw data. These processes reduce the volume of data flowing to practitioners while increasing their utility. In addition, the invention performs causal analysis for poor outcomes which may prevent further patients from exposure to less than optimal processes.

Rather than external practice guidelines, the invention uses data from specific institutions to create facility-specific standards. This functionality assures that the standards are relevant and feasible for the population of interest.

In embodiments of the invention in which health analytics are used to develop recommendations, the recommendations are made for the entire patient population, not just individuals. This functionality allows patients to be stratified according to their likelihood of benefit—a complex task in which patients are compared to one another over a variety of critical attributes. This functionality greatly increases an institution's ability to manage its resources.

Going beyond risk scores to trigger actions—that is, the likelihood that a patient will develop some future event—the invention uses a much broader range of parameters to target patients for treatment intensification including severity, complexity, acuity, actionability, need, and likelihood of benefit.

The invention creates alerts that define what action should be taken, when it should be taken, and by whom. Alerts are delivered to all levels of the organization—from management to clerical staff—so that the entire institution is involved in improving the quality of its services. The invention supports the patient centered medical home by allowing staff to function at the top of their capabilities and circumvent the bottleneck created by designating a “provider” as the sole recipient.

Provider performance is most often compared to expected standards of practice whether they are feasible or relevant to the population in question. The invention provides information of what can be achieved by the institution or much detail about how providers perform relative to one another. The invention compares actual outcomes of providers while adjusting for multiple differences in their panels. This approach is the only one supporting replication of best practices.

Importantly, the invention applies local decision rules to patients at the point of care so that recommendations are individualized and timely.

The invention divides the tasks of a physician into those that are data-intensive, others that are protocol-driven, and still others that are patient-centric. Data-intensive tasks are those which require often complex interpretation of large volumes of information including, for example, processing of view alerts, responding to clinical reminders, screening prescriptions for dosing errors and drug interactions, and reviewing laboratory results. Protocol-driven tasks are those in which care is largely dictated by widely accepted standards and for which there is little latitude in decision-making. Examples include cancer screening, vaccinations, and other preventive care; drug titration; timing of subsequent laboratory tests; and special examinations for specific diseases (such as screening for diabetic retinopathy). The third category is comprised of tasks that are patient-centered, cannot be standardized, and require a high level of interpersonal skills. One example is the complex assessment of patient values, education, negotiation, and goal-setting required for the optimal care of type 1 diabetes. Physician skills tend to vary across categories; are least well developed for those that are data-centric; and are best suited for those that are patient-centered. According to the invention, the clinician retains authority over all aspects of the practice. However, its day-to-day operation relies heavily upon data accrued from EMR's in near real-time. Analytical programs are loaded on institutional servers, set to update regularly, and process information on behalf of the clinician.

Protocol-driven tasks are divided into those handled by the Patient-Aligned Care Team (PACT) and those done at the institutional level. The difference between the two is the level of clinician input. The tasks performed by PACT team include routine re-assessment of disease status, standard titration of medications, and routine monitoring for side-effects and complications. These procedures are well defined for certain diseases but treatment parameters must be set by the clinician. On the other hand, preventive services are so standardized that the clinician needs only to decide that they are appropriate. It seems reasonable for the institution to provide services to which the clinician subscribes.

The clinician retains responsibility for patient-centric activities. Because many tasks have been off-loaded to other components of the practice, much more attention can be directed to these critical patient-provider interactions. The provider also has the option of setting individual patient parameters for the analytics. Examples include critical values for results reporting, cycle times for periodic assessments, and “opt-outs” for selected services. When the PACT team is assembled, the clinician defines the scope of practice for its members, designs templated progress notes to document team care, and creates scripted interviews for telephone contacts. The provider can then write standing orders for each patient that govern the operation of the PACT team including drug types, dose titrations, titration intervals, outcome measurements, testing frequency, and stopping rules. Finally, the provider may subscribe to services provided by the institution including vaccinations, cancer screening, and patient education.

In one embodiment, the programs according to the invention are programmed in Microsoft SQL Server, a mainframe computer program for relational databases. It is contemplated that the programs may be installed on institutional servers tied to a data warehouse, set to update automatically, and is most effective when data is captured in real time.

In one embodiment, the programs of the invention are installed on servers connected to the institutional data repository. The invention assembles records from a wide variety of data sources. However, unlike registries, the invention examines complex associations, synthesizes new clinical parameters, supports robust statistical analyses of the data, and executes algorithms that replicate the decision process of clinicians. The end-result of this analysis is one to over a dozen main tables written to the server.

Data may be retrieved into a table in a variety of formats. These tables can be placed directly in a protected folder in the user's space on the institutional computer system thereby allowing queries to be performed on the data such as by a desktop application. The use of tables also facilitates transferring data to a statistical package, merging data with word processing software to generate letters, and converting the data to a tracking log for subsequent interventions.

The invention assesses and improves quality of health care delivery. Data from EMRs for one or more patients of a patient population is retrieved. Data is retrieved by finding data expressed in non-standardized terms. This is accomplished by searching the EMR for a root syllable, an acronym, a synonym, an abbreviation, or a name variation. Non-numeric symbols from the data are eliminated and any outliers are removed using a mean value calculated for each patient of the patient population.

The data may be analyzed for a variety of purposes, including to determine variation in performance of a practice site, a group practice, or an individual clinician for the patient population on a given treatment. A comprehensive medication history database may be constructed for patients of the patient population. Provider responses to actionable clinical findings of patients of the patient population are evaluated. In addition, the invention may determine failures of a medical condition of one or more patients, for example, a failure to follow an indicated treatment, an inadequate dose of medication, an inadequate duration of treatment, a delay in switching unsuccessful strategies, or a failure to take a medication. Abnormal screening tests may be used to track progress of patients of the patient population. Abnormal screening tests may be evaluated by rating a referral to specialty care, scheduling an appointment, making a visit, scheduling a biopsy, and processing a specimen. Data from EMRs may also be used to assess use of one or more medications across the patient population. Assessing use of medications may include the steps of identifying polypharmacy patients, monitoring drug adherence, determining out-of-range dosing, deciding dose adjustments, assessing drug interactions, and monitoring a specific drug.

The EMR data may be analyzed to identify a risk of disease for patients of the patient population. For example, the data may be analyzed by using criteria such as a hospital record, an outpatient encounter, a problem list, a pharmacy record, a laboratory test, a procedure, and a surgical pathology. The EMR data may also be analyzed to prioritize the needs of the patients of the patient population, triage the patients to appropriate members of a health care team, and coordinate repeated cycles of treatment intensification and re-assessment. In addition, EMR data may be used to consider time and expense of travel for treatment by the patients of the patient population.

### BRIEF DESCRIPTION OF THE DRAWINGS

FIG. 1 illustrates a block diagram of an analytic platform according to one embodiment of the invention.

FIG. 2 illustrates a block diagram of programs for analyzing Electronic Medical Record (EMR) data according to one embodiment of the invention.

FIG. 3 illustrates an exemplary computer system 300 that may be used to implement the programs according to the invention.

### DETAILED DESCRIPTION OF THE INVENTION

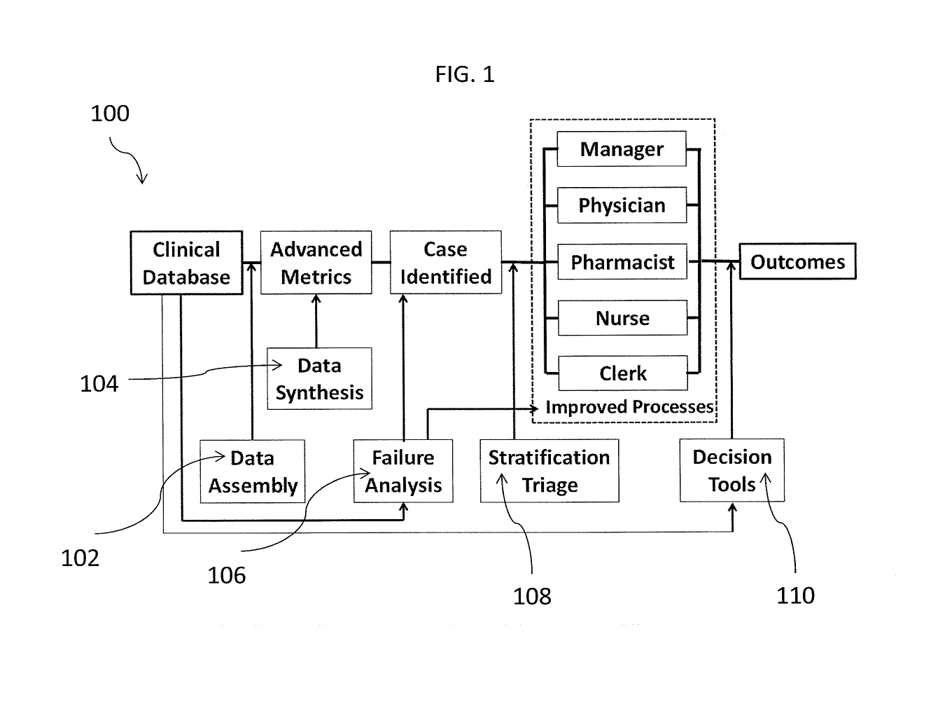

The invention is based upon a far more sophisticated approach to health analytics that takes full advantage of a robust data repository built from EMRs. The functionalities of the system and the flow of information across an organization are shown in FIG. 1.

The system and methods according to the invention supports an entire range of operations from surveillance to problem resolution. Its components facilitate the interpretation of raw data, identify and prioritize cases, direct workflow to different personnel, identify failure modes within the institution, use of the institution's own data to build standards and decision rules, and apply those rules to individual patients to maximize outcomes.

The process begins with data extraction and assembly to maximize data quality 102. Complex clinical variables are synthesized from the raw data 104. In many cases, these advanced metrics (such as a disease trajectory) are of greater relevance to the problem at hand than the raw data itself. Simultaneously, failure analysis 106 is performed to identify patients with worrisome disease manifestations, processes that have failed, or opportunities that have been missed. This analysis tests competing theories of causality to determine which are most significant and require remediation. Evaluating an entire population with a given disease allows managers to prioritize care across patients and direct services to those most likely to benefit. It also supports the replication of best practices across the facility. Both strategies improve outcomes without additional resources—a critical functionality in a time of constrained funding. Patients with critical findings are triaged to the most appropriate levels of care 108. Triage assures that members of a team are functioning at the top of their capabilities. It also improves access to care by bypassing the “bottleneck” imposed by the limited availability of the primary physician. At the same time, managers are alerted to critical processes so that they can be corrected across the institution. Finally, at the point of care, patient attributes are loaded into locally defined decision rules so that the recommendations are timely and relevant to the patient at hand 110.

The invention provides a method for assembling data 102 (FIG. 1) such that the quality of data retrieved from EMRs is improved. Data from EMRs may not be coded or expressed in standard terminology, the EMR may not use input masks or error checking to eliminate entry errors, and entries are almost always expressed in text format. For example, laboratory test results are stored as character data to accommodate values such as “cancelled”—making it necessary to convert the data type before they are interpretable. Nevertheless, when EMR data is used to drive patient care, errors in data retrieval or processing may have life-threatening implications. It is mandatory that such data be of the highest quality before they are used for decision making.

Drug and laboratory test names are often expressed in a format selected by the database architect and rarely conform to one naming convention. The invention performs the retrieval of data expressed in non-standardized terms by searching for appropriate entries in the EMR using root syllables (such as “% A1c %” for “hemoglobin A1c”), acronyms (such as “eGFR” for “estimated glomerular filtration rate”), synonyms (such as “glycohemoglobin” for “hemoglobin A1c”), abbreviations (such as “HbA1c”), name variations (such as “CK” and “CPK” for “creatine kinase” or medical jargon (such as using a noun—stent—as a verb—stented).

When possible, searching is done on reference tables to improve efficiency. The output is always expressed with the punctuation required for entry into a SQL Server data table. For example, in SQL Server, the terms are expressed as “(‘entry’),”. This approach minimizes typographical errors, handles spaces that are not visible to the programmer, and allows the programmer to copy and paste the list from the results table into the code. The list is then edited and inserted as separate terms into a reference table using the VALUES command. These reference tables are placed at the start of routines so that the user is always aware of the search criteria. For searches based upon such criteria, the reference list is joined to the other tables as a criteria set. There are several advantages to this approach: a) it avoids errors from searches using “wild cards”; b) certain entries on the list can be “commented out” to refine the search; c) search lists are not embedded in code and difficult to find; d) only one list needs to be edited for all routines using the criteria set; and e) the table serves as a reminder that these lists need to be updated periodically.

Laboratory and pharmacy data are typically entered as text that includes symbols and numbers. The invention preserves numeric data that employs non-numeric symbols (such as “>10,000”). This is performed by removing relational terms so that out-of-range are converted to their boundary values (>10,000” to “10,000”). Titers (1:40) are converted to their dilution factors (40) by reading the symbols following the colon. Values expressed in exponential notation are converted to standard notation. This is accomplished by reading the symbols after the “E”, finding the exponential for the numeric part, inverting the exponentiated expression if the symbol is negative, and multiplying the result by the significant. Typographical errors involving decimal points are handled by substituting a single for double periods and removing trailing periods. The data entry is then parsed of all characters except numbers and periods and replaced by spaces. The field is then trimmed of leading and trailing spaces. Imbedded spaces imply that there are two separate numeric values in the results field that should be manually reviewed. The results are tested for convertibility to be sure the expression is a valid numeric type. Errors may be removed before the numeric conversion procedure is applied.

Certain parameters such as body mass index vary within a predictable range for most patients. The invention retrieves data including the removal of outliers by using a “jack-knife” procedure. For each patient, a mean value is calculated over all values and the mean value is appended to each record. Each value is then compared to the mean of all other values. Deviation of each value from the mean of other values is expressed as a percent deviation. The value is deleted if the fractional deviation exceeds a value selected by the user. For example, using this technique, it is possible to remove all BMI's that deviate more than 30% from the patient's historic average.

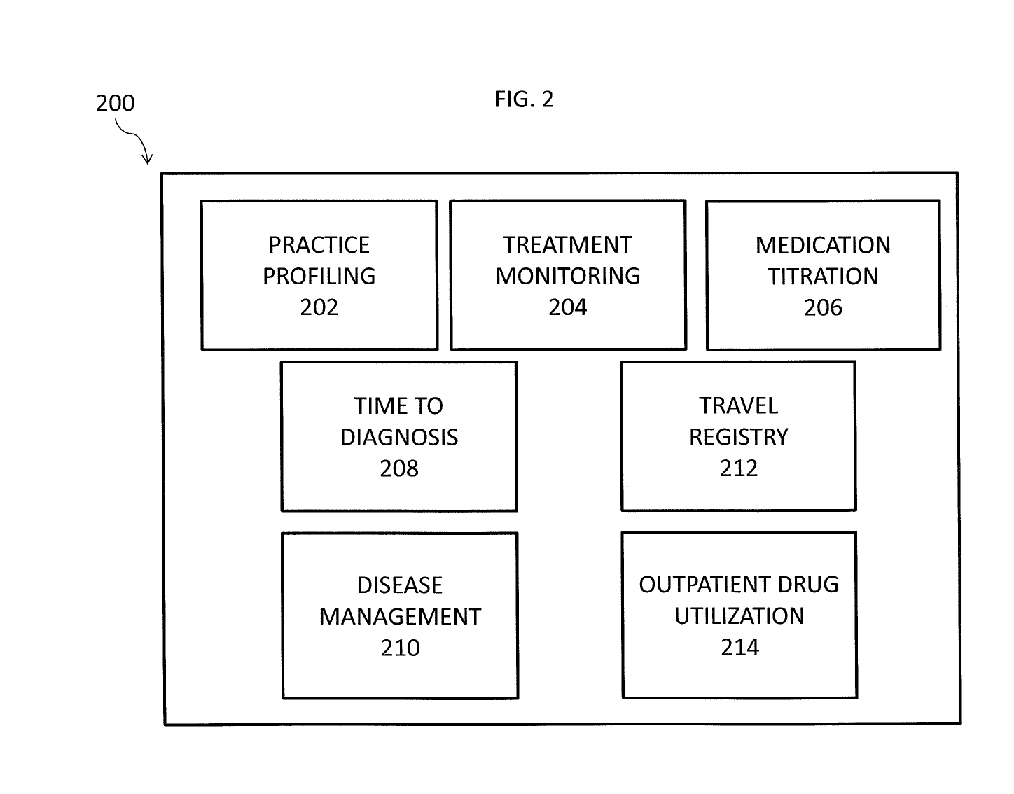

Once the data is assembled, the invention provides a method for synthesizing—or analyzing—the data 104 (FIG. 1). According to the invention, data is analyzed for a variety of purposes according to computer programs directed to practice profiling 202, treatment monitoring 204, medication titration 206, time-to-diagnosis 208, disease management 210, travel registry 212 and outpatient drug utilization 214 as shown in FIG. 2.

A practice profiling program 202 analyzes variation in the performance of practice sites, group practices, or individual clinicians for patients on a given treatment. EMR data allows for meaningful comparisons of provider performance across a health care institution. Current methods rely on manual audits of a small sample of patients from each provider's panel. This approach is inadequate because the panels may differ substantially in terms of severity or complexity, and the small sample produces a biased assessment of the provider's skills. The latter is highly likely if sampling is based upon patient activity (and misses the patients so well managed that they do not seek care). In the worst case scenario, a provider may be penalized for deficiencies in the review process. A much more rigorous approach involves 100% sampling from the provider panel and retrieving multiple covariates to adjust for differences in severity across panels. The invention provides the opportunity for such a robust approach.

As an example, the invention begins by identifying all patients with the disease in question and on a similar treatment plan, e.g., the audit may focus on type 2 diabetic patients on insulin but not oral agents. The next step is to join the outcome measure closest to the start and end of the treatment course. The next is to join any other patient factors at the start of treatment that may influence the outcome (e.g. demographic and metabolic traits). The final step is to determine if there are differences in panel-wide averages for the performance measure after adjusting for these covariates. It is contemplated that much of the differences across providers may be due to variations in patient age, gender, ethnicity, body mass index, initial severity, treatment type, and duration of follow-up. By removing these factors, any remaining differences can therefore be attributed to variation in provider skills. Provider profiling may be used to drive educational activities, provide practice support, and ultimately to improve patient outcomes.

A treatment monitoring program 204 evaluates provider response to actionable clinical findings such as an abnormal blood test or vital sign not at goal. For example, the program can link each measurement of a response variable to a prescription. This objective is accomplished by again deriving a “time on treatment” for each prescription—defined as the difference between the issue date and date that the supply is expected to be gone. This analysis is applicable to medications where the dosage form is a tablet or capsule; however, it is contemplated to be applicable to injectables, solutions, and transdermals event though they are often dispensed in excess of what is prescribed. A test is joined to a prescription if its date falls within the “time on treatment”. Because each test can be joined to multiple prescriptions, sorting and ranking is done to define the most recent association.

This approach is reasonable because clinicians order blood tests to assess current treatment, not those in the past. The result is a set of prescriptions where some are matched to the response variable and others are not. The quantity, days' supply, and tablet strength for each prescription are used to calculate a daily dose. All prescriptions for a given medication at a given dose (and their linked response variables) are then assembled into a treatment course and ranked by prescription date. The start of each course is considered a change in treatment because it represents the first exposure of the patient to that drug at the specified dose. The closest measurement of the response variable to the first prescription is then joined to the course and considered the pre-treatment value. The last linked measurement is considered the final value. Grouping by treatment course enables the user to derive the following: time from the abnormality to treatment change, time from treatment change to re-assessment, total time on treatment, number of re-tests on treatment, variation in test results on treatment, and whether the treatment course succeeded or failed. This analysis should be done for measurements not at goal and for treatment courses not at maximal dose because changes in treatment and repeated measurements of the response variable are not otherwise indicated. For two treatment courses tied to the same measurement not at goal (e.g. double therapy for hypertension), it is reasonable to analyze the most recently prescribed course because clinicians usually up-titrate the most recent additions to the patient's treatment plan.

Analyzing EMR data for treatment monitoring provides a remarkable view of how clinicians use laboratory tests or vital signs to modify treatment. It identifies patients for whom there is a long delay in the cycle between an abnormal finding and switching medications or achieving goal. Summary statistics over all patients provide insight into how the entire health care system uses the testing to monitor treatment response. The invention also performs a root-cause analysis to determine what phase of the cycle is most problematic. As a result, managers can develop interventions to assist clinicians in identifying abnormalities, initiating new treatments, assessing treatment response, and changing unsuccessful strategies. Again, the rigor and sophistication of this approach is far beyond the reach of quality improvement personnel using conventional methods.

The treatment monitoring program also determines whether a clinical abnormality requires treatment, has been treated but measured prematurely, or has been treated and due for re-assessment. This functionality reduces a large amount of data appearing on dashboards to a much shorter list of those items for which an action is indicated.

The treatment monitoring program may also use EMR data to construct a comprehensive medication history database for all patients in a disease population. The medication history database supports a far more detailed characterization of outpatient drug use for all patients treated by a health care institution. Not only does the invention identify patients taking a single formulation, but also can identify patients taking specific components of compound formulations. The purpose is to facilitate the examination of the relationship between outcomes and the multiple dimensions of drug treatment including treatment type, intensity, compliance and duration.

In one embodiment, the medication history database retrieves information regarding a particular medication including formulation name. The invention uses the formulation name to create an internal reference table that may contain, for example, generic name and tablet strength. Therefore, prescriptions can be joined to the reference table to calculate a prescribed daily dose. The application then assembles prescriptions with the same patient name, generic name of the medication, and dose into a “treatment sequence”. Within each sequence, the system self-joins consecutive prescriptions to calculate a start, a conclusion, treatment duration, a long-term adherence, average gap between prescriptions, total supply of medication and an average actual daily dose for each treatment sequence.

In another embodiment, the medication history database may identify all patients taking or not taking a certain combination of drugs or classes. Such analysis is critical when appropriate treatment is characterized by the use of multiple preparations (such as congestive heart failure or diabetes) or when certain preparations should not be prescribed in the presence of others. The technology uses the treatment sequences to divide the medication history for each patient into “treatment courses” of a specified combination of drugs. The start point or end point of any treatment course is defined by the beginning point or end point of one or more treatment sequences.

For example, consider two overlapping sequences. The start of the first drug is the beginning of a treatment course consisting of one drug. The start of the second drug represents the end of the first course and start of the second—which is now characterized by the first and second drug. The end of the first drug marks the end of the second course and start of the third which now consists of the only the second drug. The third course ends with the end of the second drug. This strategy works for any number of overlapping drug sequences. The patient's medication history is thus divided by successive break points separating different courses. The invention determines whether any sequence is part of a given course and assigns the course number if the start of the sequence is less than or equal to the start of the course and the end of the sequence is greater than the start of the course. Because each sequence has been assigned to one or more courses, it a simple matter to determine which drug sequences belong to a given course (i.e., taken simultaneously). It is also possible to use an unmatched query to determine if a drug combination is used alone (i.e., not associated with any other treatment).

The invention allows the user to calculate a total daily dose or lifetime aggregate dose across all preparations within a drug class. For example, patients with chronic pain often take a short- and long-acting preparation, while those with arthritis take different non-steroidal anti-inflammatory drugs (NSAIDs) over the course of years. The application uses potency tables to express each prescription as an equivalent dose of a class representative. It is a simple matter to add the equivalent doses to calculate the total daily dose of any treatment course in terms of the reference drug (i.e. doses of oxycodone and methadone together are expressed in morphine equivalents). Likewise, it is possible to express aggregate dose of all NSAIDS taken over a lifetime in ibuprofen equivalents). This analysis is an important feature of the chronic pain module because total daily narcotic dose in morphine equivalents is a strong determinant of addiction, while large aggregate doses of NSAIDS increase the risk of cardiac events and renal failure.

A medication titration program 206 determines the appropriate action to take for an abnormal clinical finding. A medication titration cycle consists of initial treatment, a period over which the medication reaches peak effect, and a period where the response is assessable. For example, the effect of a statin should not be evaluated for 4-6 weeks after a dose increase. When care is not coordinated, measurements of the response variable can occur at any time. Note that abnormalities can be treated, premature, or appropriately timed, but only the last finding is actionable. The invention addresses this problem by using “date mapping”. While the date of the finding (usually a laboratory test or vital sign) is known, determining which are treatable requires analyzing the pharmacy records to determine that an action has occurred. For oral medications, this process involves assigning a generic name and daily dose to each prescription, assembling all prescriptions for the same generic/dose into a treatment sequence, sorting the prescriptions by release date, identifying the first prescription for that generic/dose (by definition, a new treatment), sorting the new treatments by start date, and identifying the start date for the most recent new treatment. Prescriptions for injection therapy cannot be used to assess daily dose because medication is prescribed in excess of requirements. In this case, the formulation name, quantity, days' supply, and sig are concatenated to produce a label unique to each treatment sequence. A similar procedure is used to determine the start date of the most recent change in treatment for such injectables. Across all medications, the latest start date is then compared to the date of the finding. If finding precedes the most recent start date, the finding has been “treated” and the measurement should be repeated at the appropriate interval. If the finding occurs after the most recent start date (and hence untreated) but before a maximal response can be expected, the patient should be re-assessed when the appropriate time has lapsed. If the finding occurs after the most recent start date and the patient has reached the plateau effect of such treatment, he/she should be referred for additional treatment. Thus, this functionality allows abnormal findings to be triaged to clerical personnel for additional testing or clinical personnel for intensified treatment. The invention also identifies precisely when such testing or treatment should occur.

Together, the medication history and titration programs provide an exceptional level of insight into the use of medications by individual providers and the health system. The output should be used to identify clinicians not adhering to treatment recommendations and patients not compliant with their prescribed medications. Of course, this discovery should be followed by intensive education of the persons so identified.

A time-to-diagnosis program 208 tracks the progress of patients undergoing a diagnostic evaluation. One of the most serious lapses in care occurs when there is a delay in the diagnosis of a serious condition or worse, when the patient undergoing evaluation is lost to follow up. Abnormal screening tests include, for example those related to cancer such as prostate, colon, breast and cervix. The steps involved in evaluating abnormal screening tests consist of generating a referral to specialty care, scheduling an appointment, making a visit, scheduling a biopsy, and processing a specimen.

The invention detects a failure at any of these steps as soon as possible. The analysis begins by retrieving the patient's most recent test, referral, appointment, and visit to the specialty clinic, the most recent biopsy, and the most recent pathology report. The technology detects patients with abnormal findings but no timely referral, referral but no appointment, appointment but no outpatient encounter, visit but no biopsy, and biopsy without a pathology report. The remedial action depends upon the step that has failed. The primary care provider is alerted when a positive screening test does not generate a consult. The specialty service is notified if a consult does not result in an appointment. The patient is counseled if no visit occurs for a scheduled appointment. The special service is alerted if no biopsy occurs after the initial evaluation. Finally, the pathology service is notified if no report is generated after the biopsy. For each step, the user may specify a window that represents a timely response. This functionality is extremely useful because it captures patients who have been lost to follow up and can be used to re-design critical processes of care.

The user must specify the screening test, ICD-9 codes for the condition of interest, appropriate consult titles, names of the relevant specialty clinics, and procedure codes for biopsies. The time-to-diagnosis program retrieves dates for each step in the work-up so that cohorts can be tracked from event to event and patients who miss or are delayed at each step identified. In the case of prostate cancer screening, the program begins by retrieving the 3 most recent values and referent ranges for prostate specific antigen (PSA) which may be elevated in the presence of a malignancy. The module uses the referent ranges to determine which are abnormal and then calculates the trajectories (or differences) between the last 2 pairs of readings. The user can choose any pattern of values as an actionable finding.

For example, one normal PSA followed by one high value may require a confirmatory test. One normal followed by two high PSA values should be referred, while one normal, one high, and then one normal PSA is consistent with a self-limited condition such as prostatitis. One normal, one abnormal, and a decreasing but still abnormal third value might require yet another test because the pattern is indeterminate. Outpatient, inpatient, and problem list diagnoses are searched to eliminate prevalent cases. For the remaining cases, the time interval is calculated between the successive events in the workup. The output is a single table where each row represents one patient. Special views identify all patients with an event in one time frame of the user's choice who do not have the subsequent event in another time frame—again of the user's choice. The program also calculates summary statistics for all time intervals to describe the performance of all services participating in the diagnostic evaluation.

This time-to-diagnosis program has enormous value in retrieving patients who have “fallen through the cracks” and reducing the associated malpractice risk. Moreover, the root cause analysis determines which clinicians and services in the sequence of events do not provide their services in a timely manner. This information may lead to a review of the procedures within each service and a remedial strategy.

The disease management program 210 identifies cases of disease in a health care institution at risk for hospitalization by identifying suboptimal prevention regimens. Cases of disease are identified by using seven criteria for case ascertainment: hospitalization records, outpatient encounters, problem lists, pharmacy records, laboratory tests, procedures, and surgical pathology. As a result, the results are as complete and unbiased as possible. The initial diagnosis in each domain is identified by partitioning by patient, sorting entries in ascending order, and selecting the first entry. All first diagnoses are then pooled, partitioned by patient, and sorted in ascending order. The first of the initial entries is taken as the time of diagnosis. This process is also used to count the number of criteria met. The final step is to construct a diagnostic table containing patient identifies, date of diagnosis, number of criteria met, and the specific diagnostic criteria in each of the 7 domains.

In one embodiment, the disease management program identifies patients with one of twelve conditions: atrial fibrillation, ventricular arrhythmias, congestive heart failure, coronary heart disease, stroke, COPD, seizures, schizophrenia, bipolar disorder, depression, opioid dependence, and substance abuse. It then gathers information on all prescriptions in 16 VA drug classes: CV050 (digoxin), CV100 (beta-blockers), CV200 (calcium channel blockers), CV300 (anti-arrhythmics), CV800 (ACE inhibitors), CV805 (angiotensin receptor blockers or ARBs), RE101 (inhaled corticosteroids), BL117 (anti-platelet drugs), CN302 (benzodiazepines), CN609 (selective serotonin re-uptake inhibitors or SSRIs), CN750 (lithium), CN709 (atypical anti-psychotics), CN301 (barbiturates), CN400 (anti-seizure medications), CN101 (buprenorphine), CN101 (short-acting narcotics). The disease management program retrieves serum drug levels in 3 groups: those used for seizures (carbamazepine, phenobarbital, phenytoin, valproic acid, ethosuximide, and primidone), those for cardiac arrhythmias (digoxin, procainamide, and quinidine), and those for depression (lithium). Finally, the disease management program gathers pulses, heights, weights, and body mass index from the vital signs database and influenza and pneumococcal vaccinations. Joining these tables enables the user to identify high-risk cases, determine whether they have been prescribed indicated medications, assess patient adherence to treatment, and identify cases where treatment has not resulted in a therapeutic level (where indicated).

The travel registry program 212 considers time and expense of travel to and from the health care system. Patients living in rural areas encounter many barriers when seeking medical services. The problem is compounded by the absence of public transportation, the need to find overnight accommodations, the time away from work or family, and an unfamiliar setting when patients are most in need of social support. Because geographic isolation and poverty are strongly correlated, these impediments are often placed upon those least able to afford the conventional solution. Outsourcing of these services into these communities will solve many of these problems. Telemedicine, e-clinics, e-consults, and cellular technologies are additional methods of opening access. These resources should be placed at sites that reach the greatest number of under-served patients. Unfortunately, decisions should be based upon an analysis of travel patterns not available to most planners.

The invention uses data in outpatient clinic records and mileage tables to estimate the travel burden incurred by rural patients. Users have the option of selecting rural clinics, a municipalities, or zip codes as the originating point. The destination can be the medical center itself, a service provided by the medical center, or a specific clinic. Travel is analyzed for all combinations of originating point and destination. For each permutation (travel from 87108 to cardiology clinic ‘X’), the application estimates the number of days that patients have spent at the destination. Multiple visits occurring on the same day are handled as a single event. The days are totaled across all patients residing at the originating point. The application then expresses their travel burden in “mile-equivalents”—that is, the number of miles driven if each day at the destination required one round-trip. In this case, the results are then aggregated over all zip codes and clinics and rank ordered by mile-equivalents. The process is then repeated for municipalities or rural practices as origins and the medical center or service type as destinations. As a result, planners have a ready reference for outsourcing the services provided by that clinic.

Adverse effects of medications are one of the most common causes of preventable morbidity and mortality in many health care systems. The development of new drugs for previously untreatable diseases has led to a steady increase in the number of preparations taken by the average patient. Practice guidelines often promote the aggressive treatment of certain conditions. Regimens have also become complex—making it difficult for patients to take any of the components in a consistent manner. Survival of patients with end-organ dysfunction has improved. Finally, the increasing number of medication formulations has made it difficult for clinicians to be thoroughly familiar with many of them. Accordingly, there has been a steady increase in rates for polypharmacy, dosing outside of recommended ranges, poor adherence, treatments contraindicated in the presence of renal or hepatic disease, major drug interactions, and potential lethal complications due to high-risk drugs like warfarin.

The drug utilization program 214 assesses the use of medication across a patient population. The use of medication can be assessed by identifying polypharmacy patients, monitoring drug adherence, determining out-of-range dosing, deciding dose adjustments, assessing drug interactions, and monitoring a specific drug.

Since the risk of a drug interaction and non-adherence increases with the number of medications taken daily, polypharmacy patients can be identified by tabulating the number of oral medications taken daily for a specified interval. More specifically, the drug utilization program sums the days' supply of all prescription over the interval and then the sum is divided by the number of days. Drug adherence can be ascertained from prescription records and expressed in several formats: medication possession ratio or MPR (days' supply/refill interval); gap analysis (number of days without supplies); estimated average dose (MPR×prescribed dose). These approaches are not new and have been extensively validated.

Drug doses outside of customary ranges should always be reviewed for accuracy. The invention implements a comparison of doses to community standards (i.e. what other clinicians are prescribing). The first step is to reduce the information in prescription files to a generic name and prescribed daily dose. The next is to logarithmically transform the latter values. The reason is that dose distributions are positively skewed (i.e. have a long tail to the right) so that standard deviation cannot be readily correlated with percentile rankings. Log transformation tends to normalize positively skewed distributions so that measures of dispersion are interpretable. The next step is to calculate a mean and standard deviation for the transformed distribution. The next is to assign a z-score that reflects the extent to which the prescription deviates from the community norm. This value is derived by subtracting the log transformed mean from the log transformed dose and dividing by the standard deviation of the transformed distribution. The drug utilization program then finds prescriptions with z-scores greater than (excessively high) or less than (excessively low) values chosen by the user.

Dose adjustments may be critical, for example for renal and hepatic dysfunction. Many clinicians do not have a large body of working knowledge of drug metabolism and dose adjustments required in the presence of kidney or liver disease. Problems may arise even for experts in the field. Remedial action currently depends upon prompt notification of the prescriber who is readily available, is aware that the change is acute, knows what the patient is taking, knows what doses are appropriate for the level of injury, and motivated to take action. An action plan with so many contingencies is highly vulnerable to failure. The invention addresses this problem by continuous surveillance of renal and hepatic function and medications that should be adjusted in the presence of end-organ dysfunction. It checks the medication lists of all patients in that population and displays the daily dose for any that have a laboratory value of the user's choice. For example, it displays the daily dose of glyburide for all those with eGFR<45. Drugs may be added to the internal reference table at the user's discretion.

Most EMRs issue warnings when a provider attempts to prescribe a drug that interacts with another drug of a patient. The clinician may cancel the order or acknowledge the warning and fill the request. Once the order is submitted, all documentation about the interaction vanishes—making it impossible to follow the patient prospectively for adverse events. Very conscientious clinicians will note this problem in the progress note or external document, but such information cannot be retrieved in a reliable manner. As a result, most patients with significant interactions are lost to follow up. The invention addresses this problem by periodically monitoring all drug-drug combinations for major interactions. The first step is to retrieve each patient's active drug list. The next is to self-join the list to a copy to create all pairwise associations. The next is to compare each association to entries in a reference table containing the major interactions. The user may specify any type or number of interactions when the software is deployed. The next step is to append the most recent creatinine or alanine aminotransferase (ALT or SGPT) for each patient. The output is a list of all pairwise drug interactions across the patient population linked to measures of the organ systems most likely to be affected by drug toxicity.

The drug utilization program may monitor a specific drug, for example Warfarin. Warfarin is the drug most commonly associated with side effects resulting in death. It is often difficult to find the therapeutic dose in patients who are malnourished, have liver disease, or vary their nutrient intake. The problem is compounded by a large number of drugs that potentiate warfarin effect. For these reasons, monitoring with a prothrombin time (PT) is required on a frequent basis. However, in most health systems, there is no mechanism to identify patients who have missed their test or are started on a new drug with major interactions. Retrieval of test results is often done manually—a process highly vulnerable to errors. The invention solves this problem by identifying patients on warfarin, retrieving the most recent prothrombin time (PT), and alerting the clinician to use of new drugs with interactions. The output can be searched for out-of-range values and used to identify those who have missed tests or should be tested for potential warfarin-drug interactions.

After the EMR data is assembled and analyzed, failure can be analyzed 106 (FIG. 1). The invention uses information from EMRs to identify processes associated with poor outcomes across a health care institution. The invention uses three types of failure analysis to identify the root causes of poor outcomes and the patients affected by those processes. The “pathophysiologic” approach is based upon a deep understanding of the biological mechanisms of disease. It consists of retrieving clinical measurements of each phase of illnesses, testing competing theories of causality for the outcome, identifying which pathophysiologic process is most important, and identifying patients with the most aberrant measure of that process. For example, relapse after admission for congestive heart failure may be due to inadequate prevention, excessive weight gain prior to the hospitalization, inadequate in-hospital diuresis, or an unfavorable weight trajectory after discharge. The analysis consists of deriving measures for each of these proposed mechanisms from EMR data, constructing a multivariate model testing their contribution to relapse, prioritizing the causes, identifying patients affected by each mechanism, and then implementing a corrective action for each cause. In this case, the interventions would consist of patient counseling, weight monitoring and diuretic self-titration, revised standards for hospital discharge, or supervised post-hospital care, respectively. The “failed processes” approach consists of examining the processes of care required for a timely resolution of a clinical problem, identifying which is most responsible for failures, improving those processes, and recovering those patients who have “fallen through the cracks”. As in a preceding example, patients may experience delays in getting a biopsy for an elevated prostate specific antigen (a screening test for cancer). This delay might occur in generating consults, scheduling an appointment with the specialist, making the visit, scheduling the biopsy, or even reporting the pathologic findings. The delay associated with each step is calculated and which of those steps contributes the most to the problem is determined. The process is corrected, if necessary, within different services. Finally, the “missed opportunities” approach starts by retrieving evidence-based treatment recommendations from the literature. The invention then determines whether each patient has met the standard by identifying the specific formulation, the prescribed dose, whether prescriptions meet the standard, the level of patient adherence, the average dose taken, duration of treatment, the serum level achieved, the biologic response, measures of drug toxicity, and whether recommended drugs are used appropriately in combination. Moreover, the invention performs this analysis on all patients across the institution and at a frequency chosen by the user. This approach is remarkably effective because group interventions can be applied to patients failing each aspect of treatment. For example, patients with poor adherence may undergo motivational interviewing, while those with side-effects can be scheduled to a pharmacist for dose down-titration. In summary, this claim is for a process that identifies root causes for patients failing to achieve a desired outcome.

The invention uses EMR data to prioritize the needs of a patient population, triages cases to appropriate members of a health care team, and coordinate repeated cycles of treatment intensification and re-assessment 108 (FIG. 1). Stratification of the patient population consists of ranking cases according to their treatment priority so that resources and needs can be aligned. The rankings can be by severity, complexity, acuity, risk, actionability, likelihood of benefit, or need. Severity refers to the magnitude of injury for the disease in question and can be defined by symptoms or physiologic findings. Complexity can be defined by complications, co-morbidity, or treatment type. Acuity is defined by the time of onset, temporal trends, or urgency. Prioritization by risk allows the institution to direct preventive measures to patients who are most vulnerable. In certain cases, findings are not actionable because they are premature or already treated. In others, patients may not be ready for change or have other preferences. Likelihood of benefit is often determined by the physiologic response to treatment. For example, congestive heart failure patients with hypertension are more likely to benefit from afterload reduction than those without. Patient needs are often defined by their psychosocial functioning independent of clinical status. For example, those with low health literacy require personal counseling (as opposed to self-help approaches) more than those with high self-efficacy.

Once stratification has occurred, triage to team members is conducted. Because members of a stratum have similar needs, cases can be triaged to members of a health care team most appropriate to serve those needs. The invention supports current efforts to establish the patient centered medical home as the new model of patient care.

Finally, the invention has several functionalities that support intensification of treatment. It does so by adding recommended intervals to testing and treatment dates to identify when such interventions are due, querying the system at regular intervals for patients past due, and merging records with standard forms to create individualized notifications.

Data of EMRs can be used to implement decision tools 108 (FIG. 1). Prediction rules can be created for outcomes specific to a patient population and distributed to all relevant patients. For institutions of sufficient size, this functionality makes irrelevant any practice recommendations generated on external populations, at other institutions, and at other times or circumstances. The process consists of retrieving raw values from the data repository, deriving highly relevant variables from those values, identifying the outcomes of interest, using statistical modeling to determine which raw and derived values are associated with the outcome, and inserting that equation into the analytics. When the routine is executed, a prediction is generated for each patient by inserting his or her most recent values into the expression. Thus, the invention supports the national priority of individualizing treatment recommendations—that is, advice that is customized to meet the needs of the specific patient.

In another embodiment of the invention, required actions for all members of a disease population are identified. Specifically, a decision algorithm includes a branching schema that guides a user through a series of decisions that ultimately results in a course of action. The schema consists of decision nodes connected by branches representing a response of a user. The schema is branching because the critical decision at each level in the schema depends upon responses to the preceding nodes. Each pathway through the decision algorithm represents a unique set of such responses and terminates in a bucket that defines the required action. The invention consists of several steps that execute a decision algorithm across the entire disease population. The first step is to design the decision tree. The next step is to assemble data required for all of the decision nodes. The next is to apply a query set that evaluates all pathways through the algorithm. Each query tests for the set of patient traits defined by one pathway and identifies all patients for whom the associated action is indicated. Patients who cannot be so categorized are prompted to obtain the needed data—in most cases, a laboratory test. Iterations of this process eventually identify critical actions for every patient and continuously update the tasks required for his or her optimal treatment. This strategy represents a remarkable advance over the current art which tests for one trait, shows that an action is required, but does not specify what that action is. In addition, while conventional decision tools are applied to patients one at a time, the invention identifies next actions for an entire population. This advanced functionality is extremely useful for a variety of tasks ranging from planning and resource allocation to patient referrals.

It is also contemplated that EMR data may be used to analyze temporal changes in clinical parameters. The invention applies a number of procedures to these findings—in most cases, laboratory results or vital signs. The functionalities include deriving temporal trends; analyzing temporal patterns; calculating absolute changes over the short- and long-term; measuring time, visits, and tests continuously above goal; estimating long-term disease burden, and time-weighted averaging.

For example, the invention estimates disease burden by integrating a clinical value (e.g. blood pressure) versus time curve. The analysis begins by joining each value to its preceding one, calculating the interval between the two, and using each pair of readings and the interval to derive the area of the resulting trapezoid. The latter values are summed over all pairs to calculate the area under the severity versus time curve. The total area should correlate with the cumulative injury caused by these abnormalities over the patient's lifetime because such damage is almost always a function of severity and exposure time.

As another example, the invention is applied to glucose readings, cholesterol related values, and measures of systemic inflammation to estimate their cumulative effects over the long term. The area under the severity versus time curve is used to derive a time-weighted estimate of the former. Simple averaging of readings overstates the long-term severity because measurements are taken more frequently when they are abnormal. As a result, each abnormal value represents a shorter time frame than those that are normal. Time-weighted averaging adjusts for this bias and consists of dividing the area under the curve by the duration of follow up. “Time above goal” is defined as the number of days with an uninterrupted elevation of the parameter from the first value in the series to the present. The technology also calculates the number of clinician visits and consecutive abnormal readings. Large values for these three parameters indicate that the patient has failed rigorous attempts at treatment and that a different approach is necessary.

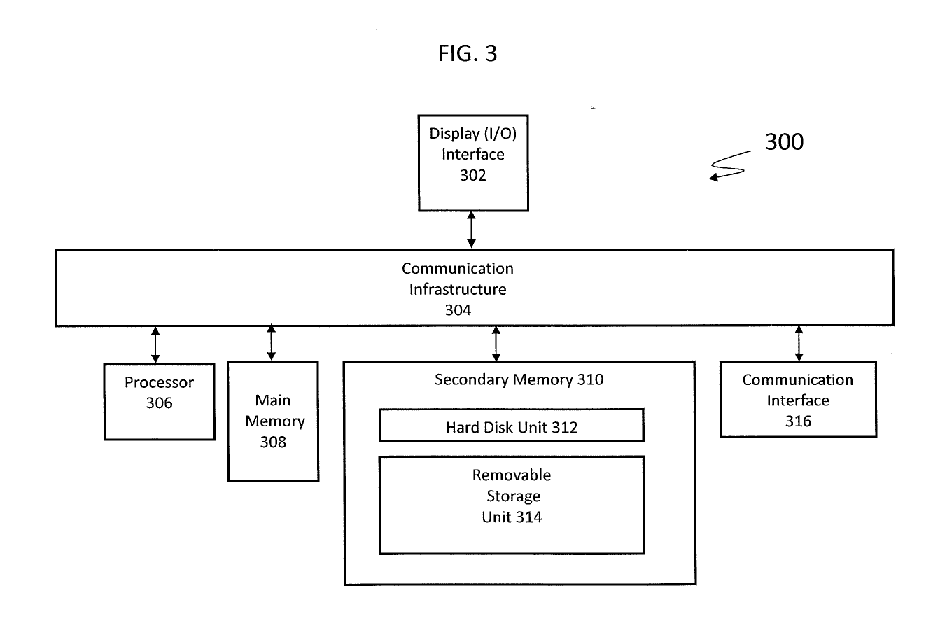

FIG. 3 illustrates an exemplary computer system 300 that may be used to implement the programs according to the invention.

Computer system 300 includes an input/output display interface 302 connected to communication infrastructure 304—such as a bus—, which forwards data such as graphics, text, and information, from the communication infrastructure 304 or from a frame buffer (not shown) to other components of the computer system 300. The input/output display interface 302 may be, for example, a keyboard, touch screen, joystick, trackball, mouse, monitor, speaker, printer, Google Glass® unit, web camera, any other computer peripheral device, or any combination thereof, capable of entering and/or viewing data.

Computer system 300 includes one or more processors 306, which may be a special purpose or a general-purpose digital signal processor configured to process certain information. Computer system 300 also includes a main memory 308, for example random access memory (RAM), read-only memory (ROM), mass storage device, or any combination thereof. Computer system 300 may also include a secondary memory 310 such as a hard disk unit 312, a removable storage unit 314, or any combination thereof. Computer system 300 may also include a communication interface 316, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 308, secondary memory 310, communication interface 316, or a combination thereof, function as a computer usable storage medium, otherwise referred to as a computer readable storage medium, to store and/or access computer software including computer instructions. For example, computer programs or other instructions may be loaded into the computer system 300 such as through a removable storage device, for example, a floppy disk, ZIP disks, magnetic tape, portable flash drive, optical disk such as a CD or DVD or Blu-ray, Micro-Electro-Mechanical Systems (MEMS), nanotechnological apparatus. Specifically, computer software including computer instructions may be transferred from the removable storage unit 314 or hard disc unit 312 to the secondary memory 310 or through the communication infrastructure 304 to the main memory 308 of the computer system 300.

Communication interface 316 allows software, instructions and data to be transferred between the computer system 300 and external devices or external networks. Software, instructions, and/or data transferred by the communication interface 316 are typically in the form of signals that may be electronic, electromagnetic, optical or other signals capable of being sent and received by the communication interface 316. Signals may be sent and received using wire or cable, fiber optics, a phone line, a cellular phone link, a Radio Frequency (RF) link, wireless link, or other communication channels.

Computer programs, when executed, enable the computer system 300, particularly the processor 306, to implement the methods of the invention according to computer software including instructions.

The computer system 300 described herein may perform any one of, or any combination of, the steps of any of the methods presented herein. It is also contemplated that the methods according to the invention may be performed automatically, or may be invoked by some form of manual intervention.

The computer system 300 of FIG. 3 is provided only for purposes of illustration, such that the invention is not limited to this specific embodiment. It is appreciated that a person skilled in the relevant art knows how to program and implement the invention using any computer system.

The computer system 300 may be a handheld device and include any small-sized computer device including, for example, a personal digital assistant (PDA), smart hand-held computing device, cellular telephone, or a laptop or netbook computer, hand held console or MP3 player, tablet, or similar hand held computer device, such as an iPad®, iPad Touch® or iPhone®.

The described embodiments are to be considered in all respects only as illustrative and not restrictive, and the scope of the invention is not limited to the foregoing description. Those of skill in the art may recognize changes, substitutions, adaptations and other modifications that may nonetheless come within the scope of the invention and range of the invention.

1. A computer system method for assessing and improving quality of health care delivery, the computer system including a processor configured to execute the steps comprising of:
retrieving by the processor data from an electronic medical record for one or more patients of a patient population;
analyzing the data for variation in performance of a practice site, a group practice, or an individual clinician for the patient population on a given treatment;
evaluating a provider response to actionable clinical findings of the one or more patients of the patient population;
determining a failure of a medical condition of the one or more patients of the patient population;
tracking progress of the one or more patients of the patient population through evaluation of an abnormal screening test; and
assessing use of one or more medications across the patient population.

2. The computer system method according to claim 1, wherein said retrieving step further comprises the steps of:
finding data expressed in non-standardized terms by searching the electronic medical record for one or more selected from the group comprising: a root syllable, an acronym, a synonym, an abbreviation, a name variation;
eliminating non-numeric symbols from the data;
removing outliers using a mean value calculated for each patient of the patient population.

3. The computer system method according to claim 1, wherein the failure of said determining step is resultant from one or more selected from the group comprising: a failure to follow an indicated treatment, an inadequate dose of medication, an inadequate duration of treatment, a delay in switching unsuccessful strategies, or a failure to take a medication.

4. The computer system method according to claim 1, wherein the evaluation of the abnormal screening test of said tracking step consists the steps of: rating a referral to specialty care, scheduling an appointment, making a visit, scheduling a biopsy, and processing a specimen.

5. The computer system method according to claim 1, further comprising the step of: identifying a risk of disease for the one or more patients of the patient population.

6. The computer system method according to claim 5, wherein said identifying step further comprises the step of using criteria selected from the group consisting of: a hospital record, an outpatient encounter, a problem list, a pharmacy record, a laboratory test, a procedure, and a surgical pathology.

7. The computer system method according to claim 1, wherein said assessing step further comprises the steps of: identifying polypharmacy patients, monitoring drug adherence, determining out-of-range dosing, deciding dose adjustments, assessing drug interactions, and monitoring a specific drug.

8. The computer system method according to claim 1, wherein said analyzing step further comprises the step of constructing a comprehensive medication history database for the one or more patients of the patient population.

9. The computer system method according to claim 1, further comprising the steps of: prioritizing the needs of the one or more patients of the patient population, triaging one or more patients to appropriate members of a health care team, and coordinating repeated cycles of treatment intensification and re-assessment.

10. The computer system method according to claim 1, further comprising the step of: considering time and expense of travel for treatment by the one or more patients of the patient population.
